(19) United States
(12) Patent Application Publication
(10) Pub. No.: US 2007/0177582 A1
(43) Pub. Date: Aug. 2, 2007

(54) Method and apparatus for providing network interworking for emergency calls

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/344,642

(22) Filed: Jan. 31, 2006

(51) Int. Cl. H04L 12/66

(52) U.S. Cl. 370/352; 370/401; 379/45; 455/404.1

(57) ABSTRACT

A method and apparatus for third party network providers to send an emergency call, e.g., an E911 call, and completion status information to the originating E911 call network providers so that the originating network providers can determine the status of all E911 calls originated from their network are disclosed.

The present invention relates generally to communication networks and, more particularly, to a method and apparatus for providing network interworking for emergency calls in communication networks, e.g. packet networks such as Voice over Internet Protocol (VoIP) networks.

### BACKGROUND OF THE INVENTION

VoIP network providers are required to provide Enhanced 911 (E911) services to their subscribers for requesting emergency assistance purposes and to provide E911 services that are equivalent in reliability and performance to the Public Switched Telephone Network (PSTN) counterpart. Failure to complete call setup of these emergency calls due to a network condition can have serious or even fatal consequences. Some VoIP network providers hand these E911 calls off to a third party network provider because they lack the facilities in their own network to provide access to selective routers operated by Local Exchange Carriers (LEC) that are used to connect E911 calls to the associated Public Safety Answering Point (PSAP).

Therefore, a need exists for a method and apparatus for providing network interworking for emergency calls in a packet network, e.g., a VoIP network.

### SUMMARY OF THE INVENTION

04 In one embodiment, the present invention provides a method for third party network providers to send an emergency call, e.g., an E911 call, completion status information to the originating E911 call network providers so that the originating network providers can determine the status of all E911 calls originated from their network.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of providing network interworking for emergency calls in a VoIP network of the present invention;

FIG. 3 illustrates a flowchart of a method for providing network interworking for emergency calls in a packet network, e.g., a VoIP network, of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

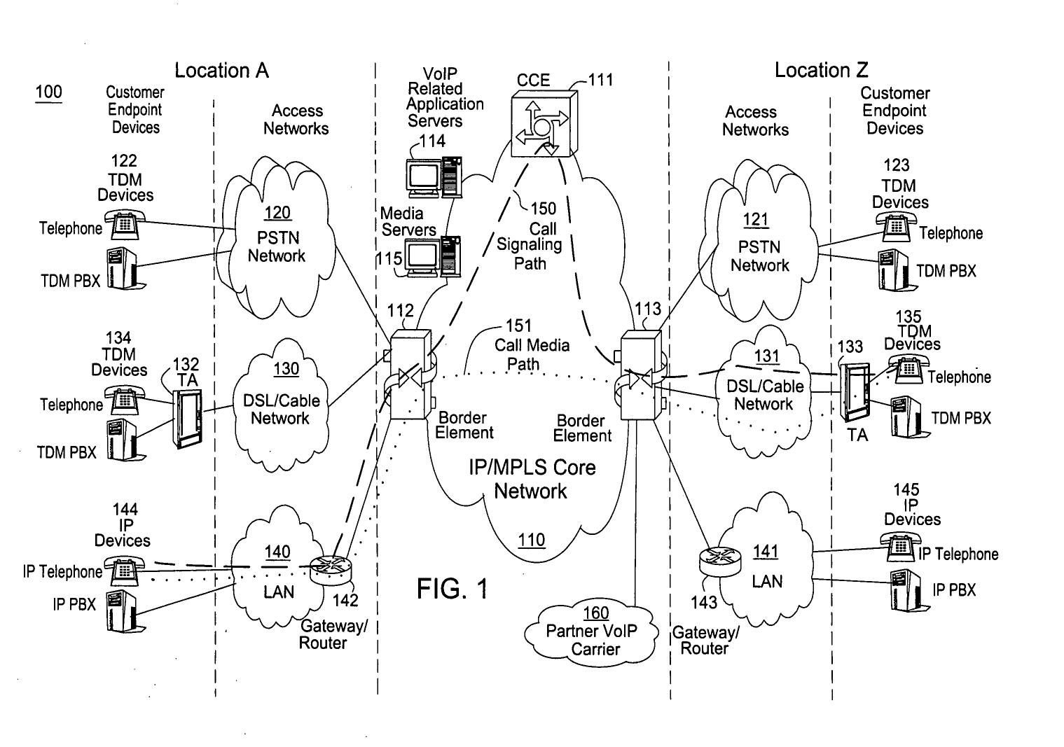

To better understand the present invention, FIG. 1 illustrates a communication architecture 100 having an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122,123,134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a SIP back-to-back user agent. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP 200 OK response message if SIP is used, is sent in the reverse direction back to the CCE 111. After the CCE 111 receives the call acknowledgement message, it will then send a call acknowledgement signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup up between two endpoints, the CCE 111 does not need to be in the data path for actual direct data exchange.

Media Servers (MS) 115 are special servers that typically handle and terminate media streams, and to provide services such as announcements, teleconference bridges, transcoding, and Interactive Voice Response (IVR) messages for VoIP service applications.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

VoIP network providers are required to provide Enhanced 911 (E911 ) services to their subscribers for requesting emergency assistance purposes and to provide E911 services that are equivalent in reliability and performance to the Public Switched Telephone Network (PSTN) counterpart. Failure to complete call setup of these emergency calls due to a network condition can have serious or even fatal consequences. Some VoIP network providers hand these E911 calls off to a third party network provider because they lack the facilities in their own network to provide access to selective routers operated by Local Exchange Carriers (LEC) that are used to connect E911 calls to the associated Public Safety Answering Point (PSAP). A selective router is a PSTN switch operated by a LEC that routes incoming E911 calls to the appropriate PSAP. E911 is an emergency response service that allows emergency personnel at a PSAP to respond to the emergency call and receive the location of a caller placing the emergency call and the calling party phone number. A PSAP is an emergency response center that is responsible for answering E911 calls for emergency assistance from police, fire and ambulance services.

To address this need, the present invention provides a method for third party network providers to send an emergency call, e.g., an E911 call, completion status information to the originating E911 call network providers so that the originating network providers can determine the status of all E911 calls originated from their network.

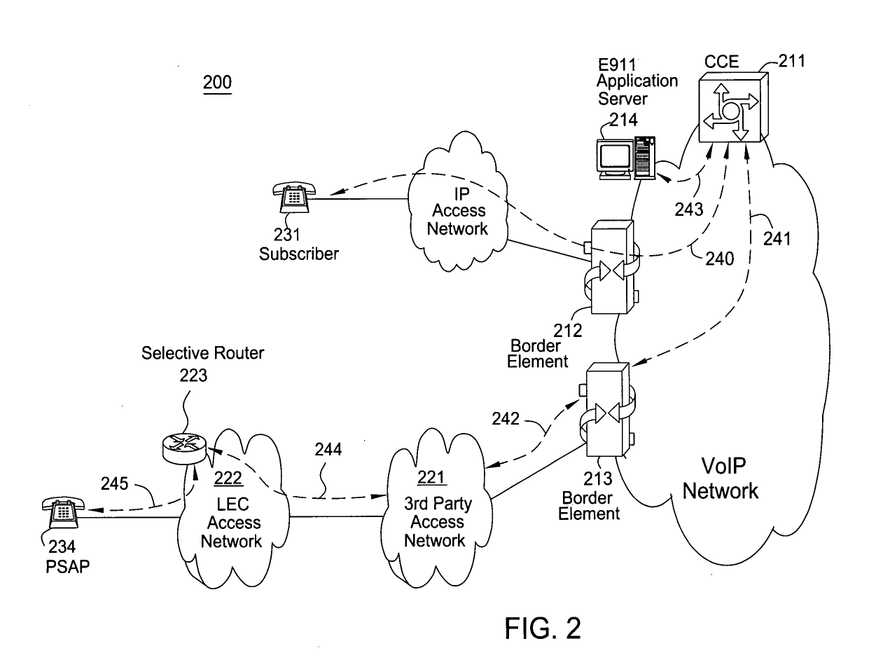

FIG. 2 illustrates an example 200 of providing network interworking for emergency calls in a packet network, e.g., a VoIP network of the present invention. In FIG. 2, subscriber 231 sends an E911 call setup message to CCE 211 via BE 212 using flow 240. Upon receiving the E911 call setup message, CCE 211 finds out that the call is an E911 call and identifies the appropriate PSAP, e.g., PSAP 234, in which the call is to be terminated. CCE 211 sends the E911 call setup message to BE 213 using flow 241 for call establishment. CCE 211 identifies PSAP 234 by communicating with E911 AS 214 using flow 243. In one embodiment, E911 AS 214 performs a lookup of the subscriber's service address using the subscriber's phone number and then uses the obtained service address to identify PSAP 234 to handle the E911 call for the service address. Then CCE 211 forwards the E911 call setup message to BE 213, the terminating BE, using flow 241. BE 213 then forwards the E911 call setup message to third party access network 221 using flow 242 for call completion.

Third party access network 221 then forwards the E911 call setup message to selective router 223 in LEC access network 222 using flow 244. In turn, selective router 223 forwards the E911 call to PSAP 234 using flow 245 for call completion. The call completion status, such as if the call is successfully completed to and answered by PSAP 234, must be communicated by PSAP 234 to selective router 223. This process is known as answer supervision. Once an answer supervision status is received by selective router 223 via flow 245 from PSAP 234, selective router 223 forwards a signaling message indicating if the call has been completed successfully or not to third party network 221 via LEC access network 222 using flow 244.

Third party access network 221 then forwards the answer supervision status message, e.g., a call success or a call failure message, to BE 213 using flow 242. BE 213 then forwards the answer supervision status message to CCE 211 using flow 241. CCE 211 then completes the call setup procedures accordingly. If the answer supervision status indicates a call is answered by PSAP 234, a call success message is received by CCE 211. CCE 211 then completes the remaining call setup procedures to complete the setup of the E911 call. If the answer supervision status indicates a call has failed to reach PSAP 234, a call failure message is received by CCE 211. CCE 211 then activates E911 call exception handling procedures for the E911 call. In one embodiment, the E911 call can be forwarded to an emergency center operated by a network provider or a third party emergency service provider instead of a PSAP, such as PSAP 234, to handle the emergency call.

25 Note that if the E911 call setup message fails to be processed en route between the terminating BE, e.g., BE 213, and the identified PSAP, e.g., PSAP 234, any call processing network element en route that detects a failure of the E911 call setup process is responsible for creating an answer supervision status message, such as a call failure message, and sending it to the preceding call processing network element to be forwarded all the way back to the terminating BE, e.g., BE 213, of the originating VoIP network, e.g., VoIP network 210.

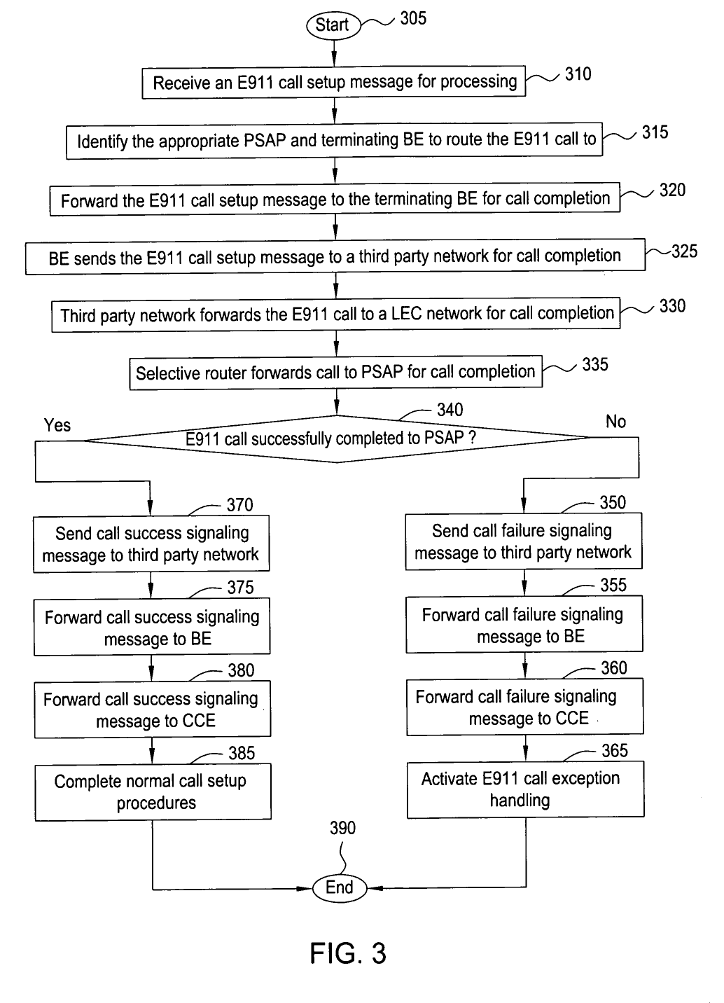

FIG. 3 illustrates a flowchart of a method 300 for providing network interworking for emergency calls in a packet network, e.g., a VoIP network, of the present invention. Method 300 starts in step 305 and proceeds to step 310.

In step 310, the method receives an E911 call setup message. For example, the E911 call setup message is received by a CCE.

28 In step 315, the method identifies the appropriate PSAP and the terminating BE for call completion. For example, the PSAP and the terminating BE are identified by the CCE. Specifically, the appropriate PSAP is identified by the CCE by communicating with an E911 AS. In one embodiment, the E911 AS performs a lookup of the subscriber's service address using the subscriber's phone number and then uses the obtained service address to identify the appropriate PSAP to handle the E911 call for the service address.

In step 320, the method forwards the E911 call setup message to the identified terminating BE to complete the call to the identified PSAP. The E911 call setup message is forwarded by the CCE.

In step 325, the method forwards the E911 call setup message to a third party access network for call completion. The E911 call setup message is forwarded by the terminating BE.

In step 330, the method forwards the E911 call setup message to the appropriate selective router hosted in a LEC network for call processing. The E911 call setup message is forwarded by the third party access network to the appropriate selective router.

In step 335, the method forwards the E911 call setup message to the identified PSAP for call completion. The E911 call setup message is forwarded by the appropriate selective router to the identified PSAP.

In step 340, the method checks if the E911 call has been successfully completed to the PSAP. For example, the answer supervision status returned by the PSAP for the E911 call is checked by the selective router. If the call has been successfully completed to and answered by the PSAP, the method proceeds to step 370; otherwise, the method proceeds to step 350.

In step 350, the method sends a call failure answer supervision status, such as a signaling message indicating a call failure to the PSAP, to the third party access network. For example, the call failure signaling message is sent by the selective router.

In step 355, the method sends the call failure signaling message to the terminating BE. For example, the call failure signaling message is sent by the third party access network. Note that if the E911 call setup message fails to be processed en route between the terminating BE and the identified PSAP, any call processing network element en route that detects a failure of the E911 call setup process is responsible for creating an answer supervision status message, such as a call failure message, and sending it to the preceding call processing network element to be forwarded all the way back to the terminating BE of the originating VoIP network.

In step 360, the method forwards the call failure message to the CCE. For example, the call failure message is forwarded by the terminating BE.

In step 365, the method activates E911 call exception handling procedures for the E911 call. In one embodiment, the E911 call can be forwarded to an emergency center operated by a network provider or a third party emergency service provider instead of a PSAP to handle the emergency call.

In step 370, the method sends a call success answer supervision status, such as a signaling message indicating a successful call completion to the PSAP, to the third party access network. For example, the call success signaling message is sent by the selective router.

In step 375, the method sends the call success signaling message to the terminating BE. For example, the call success signaling message is sent by the third party access network.

In step 380, the method forwards the call success message to the CCE. For example, the call success message is forwarded by the terminating BE.

In step 385, the method completes the remaining call setup procedures for the E911 call. For example, the remaining call setup procedures are completed by the CCE. The method ends in step 390.

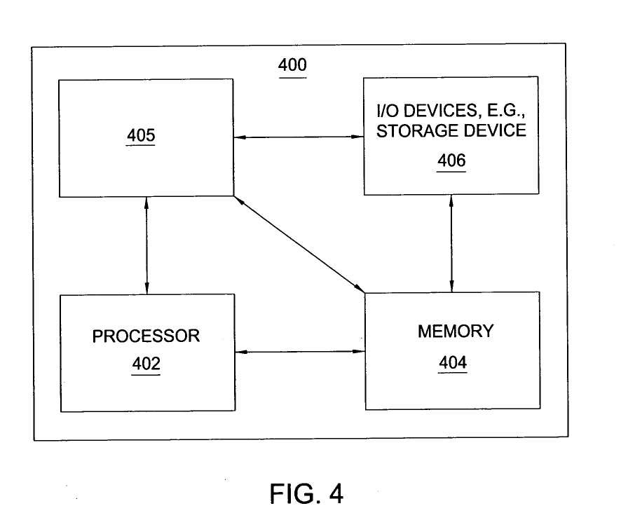

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing network interworking for emergency calls, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing network interworking for emergency calls can be loaded into memory 404 and executed by processor 402 to implement the functions as discussed above. As such, the present process 405 for providing network interworking for emergency calls (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing network interworking for emergency calls in a communication network, comprising:
receiving a call setup message associated with an emergency call in said communication network;
forwarding said emergency call setup message via a third party network to a selective router in a Local Exchange Carrier (LEC) network for call completion; and
providing an end to end answer supervision to indicate a call completion status of said emergency call.

2. The method of claim 1, wherein said communication network is a Voice over Internet Protocol (VoIP) network or a Service over Internet Protocol (SoIP) network.

3. The method of claim 1, wherein said emergency call is an Enhanced 911 (E911 ) call.

4. The method of claim 1, wherein said forwarding comprises:
identifying a Public Safety Answering Point (PSAP); and
sending said emergency call setup message to said identified PSAP via said third party network and said selective router for said call completion.

5. The method of claim 4, wherein said PSAP is identified by a Call Control Element (CCE) by communicating with an E911 Application Server (AS).

6. The method of claim 5, wherein said emergency call setup message is sent by said CCE via said third party network and said selective router via a terminating Border Element (BE).

7. The method of claim 1, wherein said providing comprises:
sending said end to end call answer supervision in a call signaling message to a Call Control Element (CCE) of said communication network indicating said emergency call has been completed successfully if said emergency call has reached and been answered by a Public Safety Answering Point (PSAP); or
sending said end to end call answer supervision in a call signaling message to said CCE of said communication network indicating said emergency call has failed to be completed successfully if said emergency call has failed to reach said PSAP.

8. The method of claim 7, wherein said end to end call answer supervision indicating said E911 call has been completed successfully is sent by said PSAP to said CCE via said selective router, said LEC network, said third party network, and a terminating Border Element (BE).

9. The method of claim 7, wherein said end to end call answer supervision indicating said E911 call has failed to be completed successfully is sent by any elements en route between and inclusive of a terminating Border Element (BE) and said selective router.

10. The method of claim 9, wherein said elements comprise call processing network elements residing in said LEC network and said third party network.

11. A computer-readable medium having stored thereon a plurality of instructions, the plurality of instructions including instructions which, when executed by a processor, cause the processor to perform the steps of a method for providing network interworking for emergency calls in a communication network, comprising:
receiving a call setup message associated with an emergency call in said communication network;
forwarding said emergency call setup message via a third party network to a selective router in a Local Exchange Carrier (LEC) network for call completion; and
providing an end to end answer supervision to indicate a call completion status of said emergency call.

12. The computer-readable medium of claim 11, wherein said communication network is a Voice over Internet Protocol (VoIP) network or a Service over Internet Protocol (SoIP) network.

13. The computer-readable medium of claim 11, wherein said emergency call is an Enhanced 911 (E911 ) call.

14. The computer-readable medium of claim 11, wherein said forwarding comprises:
identifying a Public Safety Answering Point (PSAP); and
sending said emergency call setup message to said identified PSAP via said third party network and said selective router for said call completion.

15. The computer-readable medium of claim 14, wherein said PSAP is identified by a Call Control Element (CCE) by communicating with an E911 Application Server (AS).

16. The computer-readable medium of claim 15, wherein said emergency call setup message is sent by said CCE via said third party network and said selective router via a terminating Border Element (BE).

17. The computer-readable medium of claim 11, wherein said providing comprises:
sending said end to end call answer supervision in a call signaling message to a Call Control Element (CCE) of said communication network indicating said emergency call has been completed successfully if said emergency call has reached and been answered by a Public Safety Answering Point (PSAP); or
sending said end to end call answer supervision in a call signaling message to said CCE of said communication network indicating said emergency call has failed to be completed successfully if said emergency call has failed to reach said PSAP.

18. The computer-readable medium of claim 17, wherein said end to end call answer supervision indicating said E911 call has been completed successfully is sent by said PSAP to said CCE via said selective router, said LEC network, said third party network, and a terminating Border Element (BE).

19. The computer-readable medium of claim 17, wherein said end to end call answer supervision indicating said E911 call has failed to be completed successfully is sent by any elements en route between and inclusive of a terminating Border Element (BE) and said selective router.

20. A system for providing network interworking for emergency calls, comprising:
means for receiving a call setup message associated with an emergency call in a communication network;
means for forwarding said emergency call setup message via a third party network to a selective router in a Local Exchange Carrier (LEC) network for call completion; and
means for providing an end to end answer supervision to indicate a call completion status of said emergency call.
